(19) United States
(12) Patent Application Publication
(10) Pub. No.: US 2014/0045058 A1
(43) Pub. Date: Feb. 13, 2014

(54) Graphene Hybrid Layer Electrodes for Energy Storage

(71) Applicants: Xin Zhao, Wappingers Falls, NY (US); Yu-Ming Lin, West Harrison, NY (US)

(72) Inventors: Xin Zhao, Wappingers Falls, NY (US); Yu-Ming Lin, West Harrison, NY (US)

(73) Assignee: BLUESTONE GLOBAL TECH LIMITED, Wappingers Falls, NY (US)

(21) Appl. No.: 13/570,281

(22) Filed: Aug. 9, 2012

(51) Int. Cl. H01M 4/66; H01G 4/06; H01M 4/131; H01M 4/134; B05D 3/00; B32B 9/00

(52) U.S. Cl. 429/211; 29/825; 428/408; 361/311

(57) ABSTRACT

An article of manufacture comprises an electrically conductive plate and one or more hybrid layers stacked on the electrically conductive plate. Each of the one or more hybrid layers comprises a respective sheet comprising graphene. Each of the one or more hybrid layers also comprises a respective plurality of particles disposed on the respective sheet. Finally, each of the one or more hybrid layers comprises a respective ion conducting film disposed on the respective plurality of particles and the respective sheet.

### FIELD OF THE INVENTION

The present invention relates generally to energy storage devices, and, more particularly, to graphene-based electrodes for use in energy storage devices such as batteries and supercapacitors.

### BACKGROUND OF THE INVENTION

Graphitic carbons are the most common electrode materials in conventional energy storage devices owing to their high electrical conductivity and low cost. Nevertheless, while commonly used, graphitic carbons cannot fulfill the requirements of future battery and supercapacitor devices for key emerging markets such as smart digital electronics and sustainable road transportation because of their limited charge storage and rate capability.

Graphene may be a promising alternative for graphitic carbons in energy storage devices. Graphene is a two-dimensional monolayer of carbon atoms possessing an ultrahigh theoretical surface area and a wealth of superior properties over graphite, such as high electron mobility, extraordinary flexibility, and excellent chemical tolerance. That said, reconstitution of graphene sheets in bulk electrodes tends to bring graphene sheets into a compact architecture where they aggregate and contact one another. This compaction reduces the accessible surface area and open porosity of the graphene sheets for charge transfer reactions and diffusion in the electrodes. The advantageous utility of graphene for high performance energy storage applications is thereby reduced.

Hybrid systems comprising graphene and electrochemically active materials address some of the shortcomings of electrodes based solely on graphene, although such hybrid systems are not admitted as prior art by their discussion in this Background Section. Such a graphene hybrid electrode is shown in FIG. 1. Here, an electrode 100 comprises graphene platelets 110 that are distributed among electrochemically active nanoparticles 120 (e.g., silicon, germanium, tin, tin dioxide, iron oxide, and manganese dioxide) in a polymer binder 130. In such a system, enhanced charge storage capacity and rate performance may be expected, since: (i) the active components introduce additional charge transfer reactions and ion adsorption sites; (ii) the active components function as spacers preventing the re-stacking of graphene sheets and obstruction of ion diffusion channels; (iii) the graphene network provides conducting pathways for electron transfer; and (iv) the graphene platelets mitigate the detrimental effects of volumetric changes, pulverization, and isolation of active species during charge/discharge cycling.

However, in spite of their promise, graphene hybrid electrodes such as that shown in FIG. 1 have not meet performance expectations. Such electrodes are primarily constructed from top-down graphene, that is, graphene platelets formed from the thermal or chemical reduction of graphite oxide or graphite fluoride, or from the exfoliation or separation of graphite flakes. Graphene platelets derived from graphite have varying morphology and quality. They may, for example, vary in thickness, number of layers, and consistency of properties over long length scales, and may also be highly defective. The performance of these graphene platelets is thereby compromised. In addition, manufacture of graphene hybrid electrodes like that shown in FIG. 1 generally involves casting and pressing mixed electrode constituents, including active material, carbon additives, and polymer binders, to form relatively thick, rigid films (e.g., 20-100 micrometers thick). These electrodes lack mechanical flexibility and phase segregation may occur during preparation. Moreover, the graphene platelets tend to agglomerate during repeated charge/discharge cycling because there is little intimate contact between the graphene and the active materials.

For the foregoing reasons, there is a need for alternative electrode technologies for use in high-performance energy storage devices such as batteries and supercapacitors that do not suffer from the several disadvantages described above.

### SUMMARY OF THE INVENTION

Embodiments of the present invention address the above-identified needs by providing novel multi-layered graphene composite electrode structures for high-performance energy storage devices.

Aspects of the invention are directed to an article of manufacture comprising an electrically conductive plate and one or more hybrid layers stacked on the electrically conductive plate. Each of the one or more hybrid layers comprises a respective sheet comprising graphene. Each of the one or more hybrid layers also comprises a respective plurality of particles disposed on the respective sheet. Finally, each of the one or more hybrid layers comprises a respective ion conducting film disposed on the respective plurality of particles and the respective sheet.

Additional aspects of the invention are directed to a method for forming a composite electrode. A hybrid layer is formed at least in part by: a) forming a sheet on a substrate, the sheet comprising graphene; b) depositing a plurality of particles on the sheet; c) depositing an ion conducting film on the plurality of particles and the sheet; and d) removing the substrate. Subsequently, the hybrid layer is placed on an electrically conductive plate.

Even more aspects of the invention are directed to another method for forming a composite electrode. Here, an intermediate structure is formed at least in part by: a) forming a base sheet on a base substrate, the base sheet comprising graphene; b) depositing a base plurality of particles on the base sheet; and c) depositing a base ion conducting film on the base plurality of particles and the base sheet. Each of the one or more hybrid films is formed by: a) forming a respective sheet on a respective substrate, the respective sheet comprising graphene; b) depositing a respective plurality of particles on the respective sheet; c) depositing a respective ion conducting film on the respective plurality of particles and the respective sheet; and d) removing the respective substrate. Ultimately, the one or more hybrid films are stacked on the intermediate structure. The base substrate is then removed.

### BRIEF DESCRIPTION OF THE DRAWINGS

These and other features, aspects, and advantages of the present invention will become better understood with regard to the following description, appended claims, and accompanying drawings where:

FIG. 1 shows a diagrammatic representation of a portion of a composite electrode formed with graphene platelets;

FIG. 2 shows a diagrammatic representation of a portion of a composite electrode in accordance with an illustrative embodiment of the invention;

FIGS. 3A-3H show perspective views of intermediate structures in a method in accordance with an illustrative embodiment of the invention for forming the FIG. 2 composite electrode on a current collector;

FIG. 4A-4D show perspective views of intermediate structures in an alternative method in accordance with an illustrative embodiment of the invention for forming the FIG. 2 composite electrode on a current collector; and

FIG. 4 shows a sectional view of a battery in which the FIG. 2 composite electrode may be utilized.

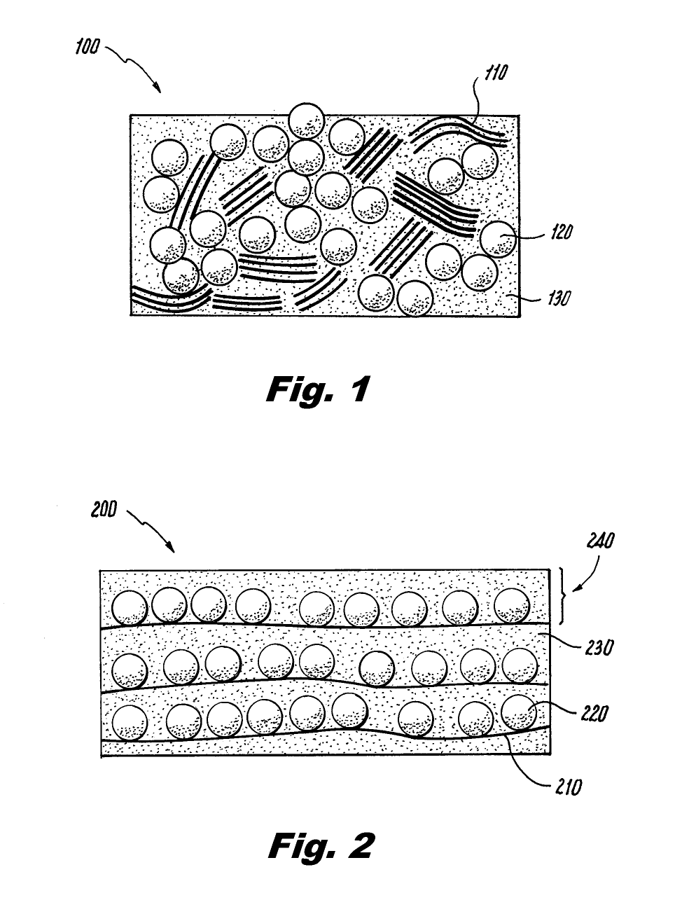

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

FIG. 2 shows a diagrammatic side-view representation of a portion of a composite electrode 200 in accordance with an illustrative embodiment of the invention. The composite electrode 200 comprises three primary constituents, namely, graphene sheets 210, active particles 220, and ion conducting films 230. These constituents are arranged in hybrid layers 240 with the active particles 220 and the ion conducting films 230 falling between the graphene sheets 210. In such a manner, the alternating graphene sheets 210 are intercalated with the active particles 220 and the ion conducting films 230. While three such hybrid layers 240 are shown in the portion of the composite electrode 200 illustrated in FIG. 2, it is contemplated that a composite electrode in accordance with aspects of the invention may include only a single hybrid layer or may include a vast number of such hybrid layers (e.g., 1,000,000 layers), depending on the application.

Each of the graphene sheets 210 in the composite electrode 200 comprises a one-atomic-layer-thick sheet of sp²-hybridized carbon. Graphene can be synthesized by several methods. High quality graphene has, for example, been formed by the repeated mechanical exfoliation of graphite (i.e., micro-mechanical alleviation of graphite) since about 2004. In addition, graphene may also be synthesized by chemical vapor deposition (CVD). U.S. Patent Publication No. 2011/0091647, to Colombo et al. and entitled “Graphene Synthesis by Chemical Vapor Deposition,” hereby incorporated by reference herein, for example, teaches the CVD of graphene on metal and dielectric substrates using hydrogen and methane in an otherwise largely conventional CVD tube furnace reactor. Graphene CVD has been demonstrated by, for example, loading a metal substrate into a CVD tube furnace and introducing hydrogen gas at a rate between 1 to 100 standard cubic centimeters per minute (sccm) while heating the substrate to a temperature between 400 degrees Celsius (° C.) and 1,400° C. These conditions are maintained for a duration of time between 0.1 to 60 minutes. Next methane is introduced into the CVD tube furnace at a flow rate between 1 to 5,000 sccm at between 10 mTorr to 780 Torr of pressure while reducing the flow rate of hydrogen gas to less than 10 sccm. Graphene is thereby synthesized on the metal substrate over a period of time between 0.001 to 10 minutes following the introduction of the methane. The same reference also teaches that the size of CVD graphene sheets (i.e., size of CVD graphene domains) may be controlled by varying CVD growth parameters such as temperature, methane flow rate, and methane partial pressure.

For applications related to energy storage, the active particles 220 preferably comprise: an electrochemically active metal (or metalloid) that can form intermetallic alloys with lithium; a transition metal oxide or electrically conducting polymeric material that can react with lithium reversibly via conversion reactions; or an intercalation material or compound that can host lithium ions in the lattice. Suitable electrochemically active metals include, but are not limited to, silicon (Si), germanium (Ge), and tin (Sn). Suitable transition metal oxides include, but are not limited to, tin dioxide (SnO₂), iron oxide (FeₓO_{y}), and manganese dioxide (MnO₂). Suitable electrically conducting polymeric materials include, but are not limited to, polyaniline (PANi), polypyrrole (PPy), and poly(3,4-ethylenedioxythiophene) (PEDOT). Finally, suitable intercalation materials include, but are not limited to, carbon materials such as graphite, carbon nanotubes, and carbon nanospheres; lithium metal phosphates such as lithium iron phosphate (LiFePO₄) and lithium manganese phosphate (LiMnPO₄); and lithium metal oxides such as lithium cobalt oxide (LiCoO₂), lithium manganese oxide (LiMn₂O₄), lithium nickel oxide (LiNiO₂), and lithium nickel manganese cobalt oxide (Li(LiₐNi_{b}Mn_{c}Co_{d})O₂). In the illustrative embodiment shown in FIG. 2, the active particles 220 are spherical, but other suitable morphologies or combinations of morphologies may also be utilized (e.g., rods, tubes, columns, wires, pills, sheets, faceted shapes). The spherical active particles 220 may have diameters between about ten nanometers and about ten micrometers, although this range is again only illustrative, and dimensions outside this range would still come within the scope of the invention. Suitable active particles 220 are available from a number of commercial sources including US Research Nanomaterials, Inc. (Houston, Tex., USA).

The ion conducting films 230 in the exemplary composite electrode 200 preferably comprise a polymeric material that facilitates the rapid diffusion of lithium. Suitable ion conducting polymeric materials include, but are not limited to, poly(ethylene oxide) (PEO), Nafion® (e.g., tetrafluoroethylene-perfluoro-3,6-dioxa-4-methyl-7-octenesulfonic acid copolymer) (registered trademark of I. Du Pont De Nemours And Company Corp., Wilmington, Del., USA), poly(acrylic acid) (PAA), poly(diallyldimethyl-ammonium chloride) (PDDA), poly(ethyleneimine) (PEI), and poly(styrenesulfonate) (PSS). These materials can be sourced from commercial vendors such as Sigma-Aldrich (St. Louis, Mo., USA). In the composite electrode 200, the ion conducting films 230 are not substantially thicker than the diameters of the spherical active particles 220 so as to achieve the maximum concentration of hybrid layers 240 in a given electrode.

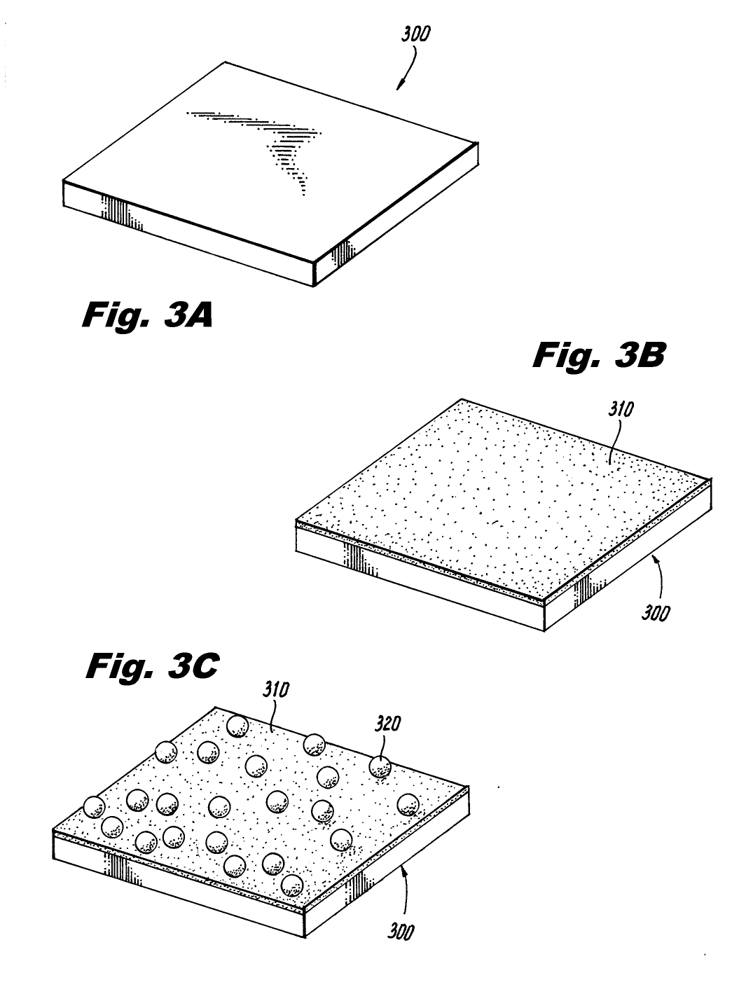

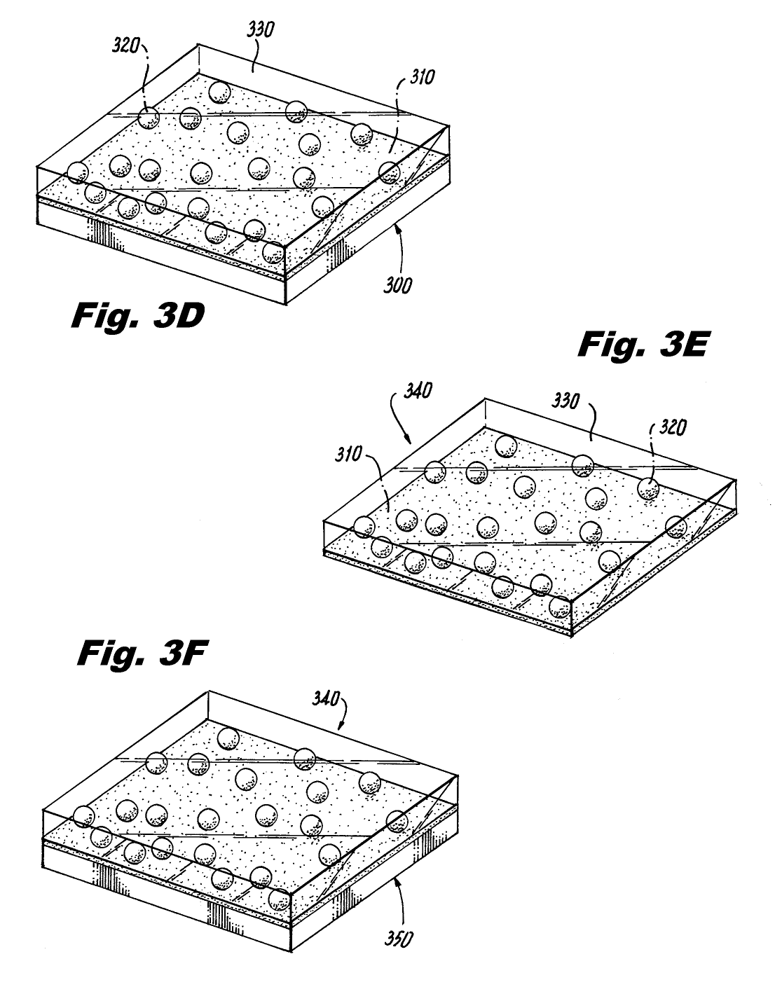

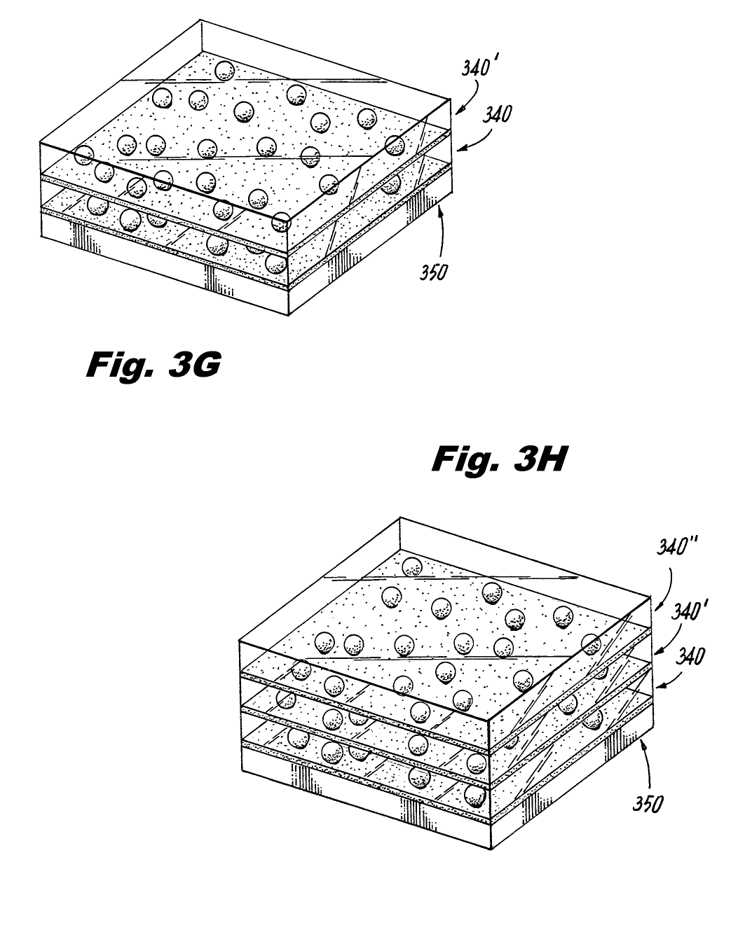

FIGS. 3A-3H show perspective views of intermediate structures in an exemplary processing sequence (i.e., exemplary method) in accordance with aspects of the invention which is capable of forming a composite electrode like that shown in FIG. 2 on a current collector (i.e., an electrically conductive plate adapted to collect or disburse electrons in an energy storage device). Advantageously, while the sequence of steps and the ultimate product are entirely novel, the exemplary processing sequence utilizes several fabrication techniques (e.g., CVD, spray coating, dip coating, spin coating, baking, pressing, wet chemical etching, etc.) that will already be familiar to one having ordinary skill in, for example, the semiconductor or nanotechnology fabrication arts. Many of these conventional fabrication techniques are also described in readily available publications, such as: W. Choi, et al., Graphene: Synthesis and Applications, CRC Press, 2011; D. B. Mitzi, Solution Processing of Inorganic Materials, John Wiley & Sons, 2009; and M. Kohler, Etching in Microsystem Technology, John Wiley & Sons, 2008, which are all hereby incorporated by reference herein. The conventional nature of many of the fabrication techniques further facilitates the use of largely conventional and readily available tooling.

The exemplary method starts in FIG. 3A with a bare substrate 300. In this particular embodiment, the substrate 300 comprises copper (Cu) or nickel (Ni), but other equally suitable materials may also be utilized. The substrate 300 is exposed to graphene synthesis. The graphene may, for example, be formed by CVD, as detailed above. After this processing, a graphene sheet 310 is present on the surface of the substrate 300, as shown in FIG. 3B.

Subsequent processing causes active particles 320 to be deposited on the graphene sheet 310. As was detailed above, the active particles 320 may comprise, as just a few examples, a metal (or metalloid), a transition metal oxide, a lithium metal phosphate, a lithium metal oxide, an electrically conducting polymer, or a carbon nanostructure. Deposition of the active particles 320 onto the graphene sheet 310 may be by, for example, spray coating or dip coating in a suitable solvent. Suitable solvents can be, but are not limited to, water, ethanol, isopropanol, tetrahydrofuran (THF), and N-methyl-2-pyrrolidone (NMP). After the solvent is allowed to evaporate, the active particles 320 remain behind on the surface of the graphene sheet 310, as shown in FIG. 3C.

Once so formed, an ion conducting film 330 is deposited on the intermediate structure shown in FIG. 3C to yield the intermediate structure shown in FIG. 3D. As was also detailed above, the ion conducting film 330 may comprise, for example, one of several polymeric materials. Like the active particles 320, deposition of the ion conducting film 330 may also be by spray coating or dip coating, as well as by conventional spin coating. Once deposited, the ion conducting film 330 is allowed to dry or is cross-linked by mild baking With the graphene sheets 310 and the active particles 320 now adhered to and/or incorporated into the ion conducting film 330, the substrate 300 is then chemically etched away to produce the intermediate structure shown in FIG. 3E. Any solvent capable of selectively removing the substrate 300 without damaging the remaining ion conducting film 330, the active particles 320, and the graphene sheet 310 may be utilized for the wet chemical etching. If the substrate 300 comprises copper, the substrate 300 may be selectively removed by immersing the intermediate structure in FIG. 3D in a solution comprising, for example, ammonium persulfate or nitric acid. If, instead, the substrate 300 comprises nickel, a solution comprising, for example, nitric acid, hydrofluoric acid, sulfuric acid, or an acid/hydrogen-peroxide mixture may be utilized. The intermediate structure in FIG. 3E is a hybrid layer 340 that is substantially identical to one of the hybrid layers 240 in FIG. 2.

In subsequent processing, the intermediate structure in FIG. 3E (i.e., the hybrid layer 340) is stacked on a current collector 350 to produce the intermediate structure shown in FIG. 3F. The current collector 350 may comprise, for example, nickel (Ni), stainless steel, aluminum (Al), or copper (Cu). Additional hybrid layers are then added to the intermediate structure in FIG. 3F one at a time. Another hybrid layer 340′, for example, produced by the same sequence of processing described with reference to FIGS. 3A-3E, is added to the intermediate structure in FIG. 3F to yield the intermediate structure in FIG. 3G. Even another hybrid layer 340″ is then added to yield the intermediate structure in FIG. 3H. This one-at-a-time linear sequence of stacking continues until the desired number of hybrid layers is stacked on the current collector 350 and the sought after hybrid-layer/current-collector combination is formed. Any number of hybrid layers may ultimately be stacked in this manner.

There are various ways of stacking the hybrid layers. In one or more embodiments, the intermediate structure in FIG. 3G is formed from the intermediate structure in FIG. 3E by, for example, allowing the hybrid layer 340′ to initially float on the surface of a liquid (e.g., water). The combination of the hybrid layer 340 and the current collector 350 are then positioned in the liquid under the hybrid layer 340′ and lifted upward using an appropriate support until the hybrid layer 340′ comes to rest on top of the hybrid layer 340.

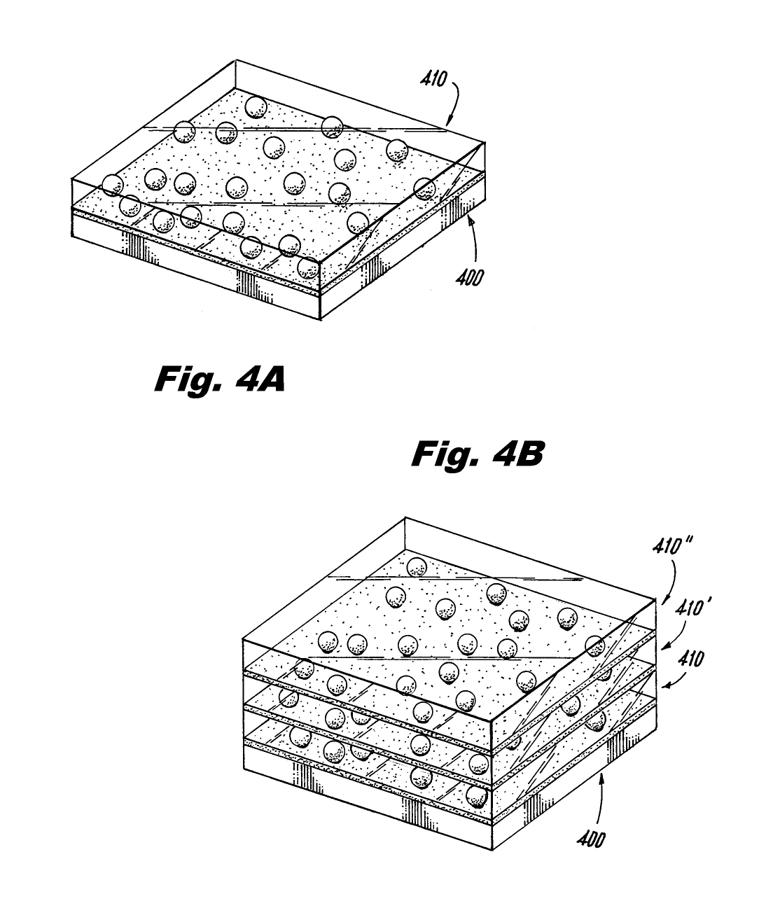

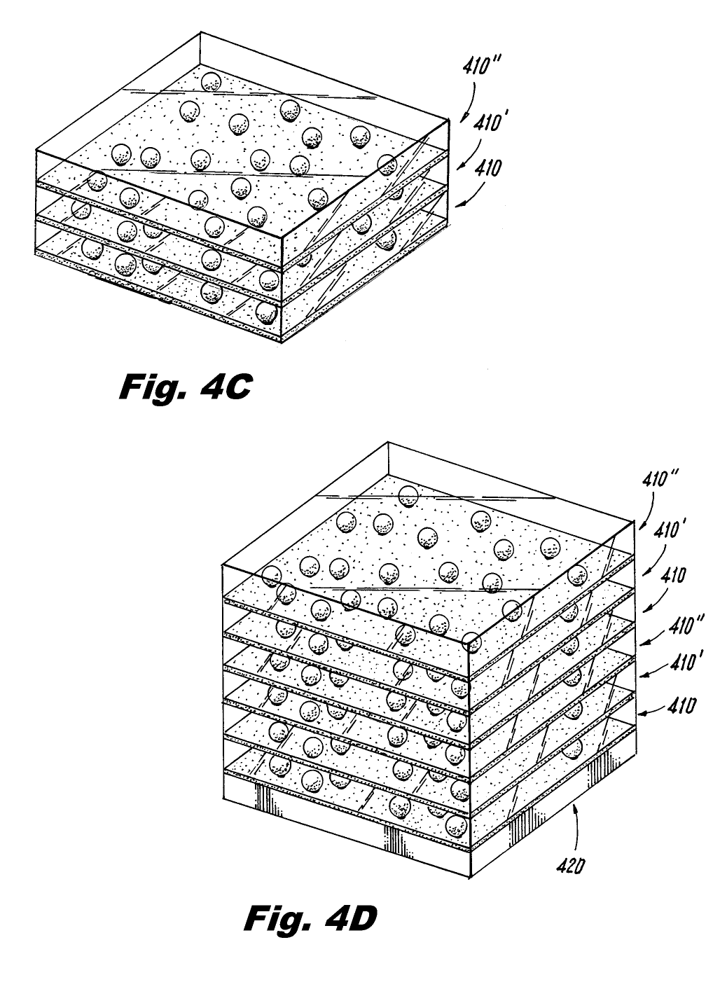

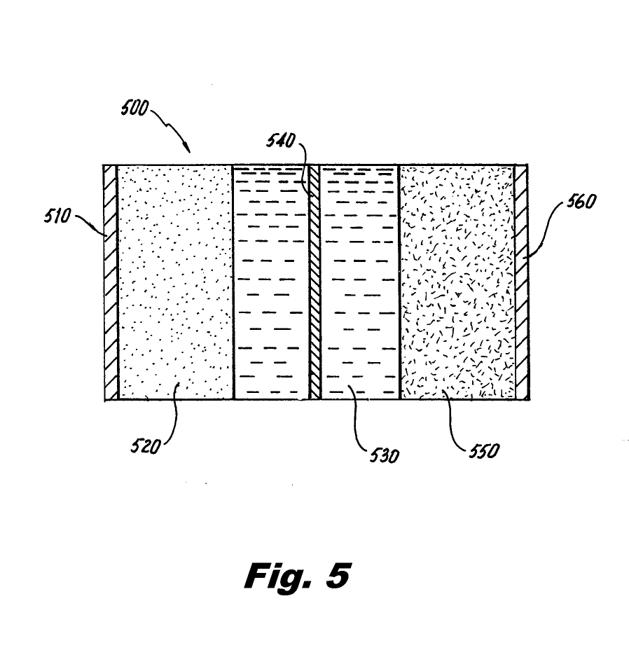

It should be noted that several variations on the above-described processing sequence are available and will also fall within the scope of the invention. One such alternative processing sequence, which may enhance fabrication efficiency, is now described with reference to the perspective views shown in FIGS. 4A through 4D. The alternative processing sequence is initiated in the same manner as the prior processing sequence, that is, a metal substrate is exposed to graphene synthesis to produce a graphene sheet on the substrate (FIG. 3B). Subsequently, active particles and an ion conducting film are deposited on the graphene sheet (FIG. 3D). The resultant intermediate structure is shown in FIG. 4A with a substrate 400 and a base hybrid layer 410. FIG. 4A is substantially identical to the intermediate structure shown in FIG. 3D.

Successive processing steps, however, diverge from those already described above. More particularly, instead of removing the substrate 400 in the next processing step, the alternative processing sequence causes several additional hybrid layers to be stacked on the intermediate structure in FIG. 4A with the substrate 400 still in place. Those additional hybrid layers may be formed using the same sequence of processing described with reference to FIGS. 3A-3E above. The addition of two additional hybrid layers 410′, 410″ to the intermediate structure in FIG. 4A results in the intermediate structure shown in FIG. 4B. In this particular example, the resultant intermediate structure includes three hybrid layers in total. Nevertheless, it should again be emphasized that this particular number of hybrid layers is entirely illustrative and alternative embodiments with a greater or a smaller number of hybrid layers would also fall within the scope of the invention. It is envisioned, for example, that an intermediate structure with many hundreds or many thousands of hybrid layers may be formed at this stage in the processing sequence.

Once the intermediate structure in FIG. 4B is built up to the extent desired, the substrate 400 is finally removed by wet chemical etching to achieve the intermediate structure in FIG. 4C. This multi-layered structure is then stacked onto a current collector to achieve the hybrid-layer/current-collector combination in FIG. 4D. Here, for illustrative purposes, two stacks of three-hybrid-layers-each 410, 410′, 410″ have been stacked onto an current collector 420. Accordingly, rather than being built up one hybrid layer at a time, as was the case in the prior processing sequence (FIGS. 3A-3H), the structure in FIG. 4D is built up by stacking hybrid layer stacks that each include more than one hybrid layer. Again, such stacking can continue until a desired thickness for the composite electrode is eventually achieved.

With the desired number of hybrid layers stacked on a current collector (by, for example, one of the two processing sequence variations described above), an optional annealing and/or pressing step may be applied to that structure. Such a step may act to thin down the ion conducting films and may also enhance the linkages between layers. Ultimately, the mechanical strength of the resultant structure may be so enhanced.

Composite electrodes in accordance with aspects of the invention like the composite electrode 200 may be utilized in energy storage devices such as lithium-ion batteries and supercapacitors (also frequently called “ultracapacitors” and “supercondensers,” and including “electrochemical double-layer capacitors” (EDLCs) and “pseudocapacitors”). FIG. 5 shows a sectional view of a lithium-ion battery 500 in accordance with an illustrative embodiment of the invention in which the composite electrode 200 may be utilized. The lithium-ion battery 500 includes a positive current collector 510, a cathode 520, an electrolyte 530, a separator 540, an anode 550, and a negative current collector 560. Lithium-ion batteries (without novel composite electrodes like the composite electrode 200) are widely manufactured and are generally described in several references, including K. Ozawa, Lithium Ion Rechargeable Batteries, John Wiley & Sons, 2012, which is hereby incorporated by reference herein.

The composite electrode 200 may variously form the cathode 520 and the anode 550 in the lithium-ion battery 500. In one non-limiting illustrative embodiment, for example, the composite electrode 200 forms the anode 550 and includes active particles 220 comprising an electrochemically active metal (e.g., Si, Ge, Sn), a transition metal oxide (e.g., SnO₂, FeₓO_{y}, MnO₂), an electrically conducting polymeric material (e.g., PANi, PPy, PEDOT), or a carbon nanostructure. The cathode 520 consists of a lithium metal phosphate or lithium metal oxide (e.g., LiFePO₄, LiMnPO₄, LiCoO₂, LiMn₂O₄, LiNiO₂, Li(LiₐNi_{b}Mn_{c}Co_{d})O₂)), sulfur or lithium sulfide, a layered metal oxide or sulfide (e.g., MnO₂, V₂O₅, MoO₃, TiS₂), or an active organic (e.g. conducting polymers, oxocarbon salt Li₂C₆O₆), with a polymeric binder and conducting carbon black or graphite. In another illustrative embodiment, the composite electrode 200 instead forms the cathode 520 and includes active particles 220 comprising a lithium metal phosphate or lithium metal oxide, while the anode 550 consists of graphite flakes, a polymeric binder, and conducting carbon black. Finally, in a last illustrative embodiment, the composite electrode 200 forms both the cathode 520 and the anode 550. The cathode 520 contains active particles 220 comprising lithium metal phosphate or lithium metal oxide, while the anode 550 includes active particles 220 comprising an electrochemically active metal, a transition metal oxide, an electrically conducting polymer, or a carbon nanostructure.

In any one of these variations of the lithium-ion battery 500, the positive current collector 510 may comprise, for example, aluminum (Al), while the negative current collector 560 may comprise, for example, copper (Cu). The separator 540 may be a microporous membrane that may be made from polyolefins, including, but not limited to, polyethylene, polypropylene, and polymethylpentene. Such separators are commercially available from sources such as Celgard LLC, (Charlotte, N.C., USA). The electrolyte 530 may consist of a lithium metal salt solvated in an appropriate solvent. Typical electrolytes include a lithium salt such as lithium hexafluorophosphate (LiPF₆), lithium tetrafluoroborate (LiBF₄), and lithium perchlorate (LiClO₄) in an organic solvent such as ethylene carbonate, dimethyl carbonate, and diethyl carbonate. Suitable salts and solvents can also be obtained from, for example, Sigma-Aldrich (St. Louis, Mo., USA).

A supercapacitor has a structure similar to the lithium-ion battery 500 illustrated in FIG. 5, and therefore is not separately illustrated herein. Supercapacitors (without novel composite electrodes like the composite electrode 200) are widely manufactured and are generally described in several references, including B. E. Conway, Electrochemical Supercapacitors: Scientific Fundamentals and Technological Applications, Springer, 1999, which is hereby incorporated by reference herein. In one non-limiting embodiment of a supercapacitor, the composite electrode 200 forms the cathode 520 and includes active particles 220 comprising a metal oxide, a lithium metal phosphate or oxide, or an electrically conducting polymer. The anode 550 consists of activated carbon, polymeric binders, and conducting carbon black or graphite.

The unique physical and electrical characteristics of the composite electrode 200 shown in FIG. 2 and, more generally, composite electrodes in accordance with aspects of the invention, impart several advantages to energy storage devices in which those composite electrodes are implemented. For example, the ultra-thin hybrid layers 240, with their graphene sheets 210, active particles 220, and ion conducting films 230, inhibit the re-stacking of the graphene sheets 210. A large specific surface area is thereby maintained for ion adsorption in comparison to electrodes solely comprising graphene sheets. At the same time, because of their relatively large lateral dimensions, low-defect densities, and long-range ordering, the continuous graphene sheets 210 promote electron conduction throughout the electrode and minimize the structural inhomogeneity originating from phase segregation. These characteristics give rise to a large specific capacity, rate capability, and cycling life.

What is more, since the graphene sheets may be oriented substantially parallel to one another in composite electrodes in accordance with aspects of the invention, the resultant multi-layered structures exhibit excellent mechanical robustness and integrity. They also remain highly flexible. These physical and electrochemical properties can be further tuned by modifying the graphene structure, surface functional groups, and orientation and interactions with the active particles and ion conducting films.

In addition, composite electrodes in accordance with aspects of the invention provide a versatile platform to manipulate multi-layered electrode structures at the nanoscopic level, which permits the precise control of electrode composition and the systematic variation of electrode film parameters. A given electrode may, for example, contain active particles that vary in concentration, composition, and/or morphology depending on their position in the stack.

Lastly, as even another advantage, composite electrodes in accordance with aspects of the invention, like the illustrative composite electrode 200, can be formed without the need to thermally or chemically reduce graphite oxide, graphite fluoride, graphene oxide, or graphene fluoride. As a result, the resultant graphene sheets have low defect densities and very high electrical conductivities. This ultimately yields a low internal resistance throughout the electrodes and an enhanced rate capability.

It should again be emphasized that the above-described embodiments of the invention are intended to be illustrative only. Other embodiments can use different processing steps, and different types and arrangements of elements to implement the described functionality. These numerous alternative embodiments within the scope of the appended claims will be apparent to one skilled in the art.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in 35 U.S.C. §112, ¶6. In particular, the use of “step of in the claims herein is not intended to invoke the provisions of 35 U.S.C. §112, ¶6.

1. An article of manufacture comprising:
(a) an electrically conductive plate; and
(b) one or more hybrid layers stacked on the electrically conductive plate, each of the one or more hybrid layers comprising:
(i) a respective sheet, the respective sheet comprising graphene;
(ii) a respective plurality of particles disposed on the respective sheet; and
(iii) a respective ion conducting film disposed on the respective plurality of particles and the respective sheet.

2. The article of manufacture of claim 1, wherein the ion conducting film comprises a polymeric material.

3. The article of manufacture of claim 2, wherein the polymeric material comprises at least one of poly(ethylene oxide), tetrafluoroethylene-perfluoro-3,6-dioxa-4-methyl-7-octenesulfonic acid copolymer, poly(acrylic acid), poly(diallyldimethyl-ammonium chloride), poly(ethyleneimine), and poly(styrenesulfonate).

4. The article of manufacture of claim 1, wherein the one or more pluralities of particles comprise at least one of silicon, germanium, and tin.

5. The article of manufacture of claim 1, wherein the one or more pluralities of particles comprise a transition metal oxide.

6. The article of manufacture of claim 1, wherein the one or more pluralities of particles comprise at least one of a lithium metal phosphate and a lithium metal oxide.

7. The article of manufacture of claim 1, wherein the one or more pluralities of particles comprise an electrically conducting polymer.

8. The article of manufacture of claim 1, wherein the one or more pluralities of particles comprise a carbon nanostructure.

9. The article of manufacture of claim 1, wherein the article of manufacture comprises an energy storage device.

10. The article of manufacture of claim 9, wherein the energy storage device comprises a battery.

11. The article of manufacture of claim 9, wherein the energy storage device comprises a supercapacitor.

12. The article of manufacture of claim 9, wherein the electrically conductive plate comprises a current collector.

13. A method comprising the steps of:
(a) forming a first hybrid layer at least in part by the steps of:
(i) forming a first sheet on a first substrate, the first sheet comprising graphene;
(ii) depositing a first plurality of particles on the first sheet;
(iii) depositing a first ion conducting film on the first plurality of particles and the first sheet; and
(iv) removing the first substrate; and
(b) placing the first hybrid layer on an electrically conductive plate.

14. The method of claim 13, further comprising the steps of:
(c) forming a second hybrid layer at least in part by the steps of:
(i) forming a second sheet on a second substrate, the second sheet comprising graphene;
(ii) depositing a second plurality of particles on the second sheet;
(iii) depositing a second ion conducting film on the second plurality of particles and the second sheet; and
(iv) removing the second substrate; and
(d) placing the second hybrid layer on the first hybrid layer.

15. The method of claim 13, wherein the step of forming the first sheet comprises chemical vapor deposition.

16. The method of claim 15, wherein the chemical vapor deposition utilizes at least methane and hydrogen.

17. The method of claim 13, wherein the method does not comprise reducing graphite oxide, graphite fluoride, graphene oxide, or graphene fluoride.

18. The method of claim 13, wherein the step of removing the first substrate comprises wet chemical etching.

19. The method of claim 13, wherein the step of depositing the first plurality of particles comprises at least one of dip coating and spray coating.

20. The method of claim 13, wherein the step of depositing the first ion conducting film comprises at least one of dip coating, spray coating, and spin coating.

21. The method of claim 13, further comprising the step of annealing the first hybrid layer.

22. The method of claim 13, further comprising the step of pressing the first hybrid layer.

23. A method comprising the steps of:
(a) forming an intermediate structure at least in part by the steps of:
(i) forming a base sheet on a base substrate, the base sheet comprising graphene;
(ii) depositing a base plurality of particles on the base sheet; and
(iii) depositing a base ion conducting film on the base plurality of particles and the base sheet;
(b) forming each of one or more hybrid layers at least in part by:
(i) forming a respective sheet on a respective substrate, the respective sheet comprising graphene;
(ii) depositing a respective plurality of particles on the respective sheet;
(iii) depositing a respective ion conducting film on the respective plurality of particles and the respective sheet; and
(iv) removing the respective substrate;
(c) stacking the one or more hybrid layers on the intermediate structure; and
(d) removing the base substrate.

24. The method of claim 23, further comprising the step of placing a product of step (d) on a structure that comprises an electrically conductive plate.
